(19) United States
(12) Patent Application Publication
(10) Pub. No.: US 2002/0019835 A1
(43) Pub. Date: Feb. 14, 2002

(54) Metod of planning appointments and electronic organiser therefor

(76) Inventors: Reinhold Baur, Neu-Ulm (DE); Eero Miettinen, Espoo (FI); Maximiliano Roque-Cerna, Gunzburg (DE)

Correspondence Address: PERMAN & GREEN, 425 POST ROAD, FAIRFIELD, CT, 06430, US

(21) Appl. No.: 09/875,470

(22) Filed: Jun. 6, 2001

(30) Foreign Application Priority Data
Jun. 9, 2000 (DE) 10028660.7

(51) Int. Cl. G06F 15/00

(52) U.S. Cl. 707/503; 707/530

(57) ABSTRACT

The invention is concerned with the improvement of electronic organisers (10), in particular with those organisers (10) which give the user a message at a time before an appointment. To accomplish this, an electronic organiser (10), a calendar (11) in which appointments can be set at least according to place, date and time, a module (16) for determining geographical positions and an assembly (17) for the ascertainment and output of distances are required. Moreover the organiser (10) with an interface (12) can exchange data with the module (16) and the assembly (17). If an appointment is entered in the calendar (11), the data connected with this appointment are transmitted to the assembly (17). Depending on the geographical position, the period of time for reaching the appointment is then calculated by means of the assembly (17) and, if the instantaneous time plus the calculated period of time corresponds to the data of the appointment, the user is given a signal.

### Description

1. Technical field

The invention is concerned with the improvement of electronic organisers, in particular with those organisers which give the user a message at a time before an appointment, as well as with a corresponding method therefor.

2. State of the art

In the state of the art, for some time now there has been knowledge of organisers in which data can be entered for the organisation and coordination of appointments and which give the user an indication that, indicating the time on this or the next day, a certain appointment is fixed. But these details and indications to the user are helpful only to a limited extent. If, for example, the appointment is connected with a change of location, the user does not get exact instructions as to when he must finally set off in order to reach the appointment reliably. Of course it is possible to set the organiser so as to give the user the instruction to set off, taking into account values based on experience and user settings; however, this is not an exact indication. If for example the user more frequently takes the Karlsruhe to Munich road and if, because of his past experience of this road, the user has entered an average speed of 95 km/h, he will not be able to keep his appointment in Munich if he suddenly only achieves an average speed of 70 km/h due to heavy traffic and/or bad weather. There is similarly poor time management if the user wants to travel on the same road during the early morning hours. If it is assumed that there is not yet any congestion during the early morning hours and an average speed of 120 km/h is realistic, the organiser programmed for the assumed 95 km/h will give the signal to set off too early. The known organisers fail completely if the starting point is no longer, as assumed, Karlsruhe, but Frankfurt.

It is therefore the object of the invention to provide a method and an organiser in order to be able to give the user a message for reaching the next appointment in time very realistically, regardless of fixed values based on experience and/or user input on the road.

### ACCOUNT OF THE INVENTION

The object for a device is achieved with the characteristics according to claim 1, and the object for a method with the characteristics of claim 8. Advantageous embodiments and developments of the invention can be found in the subsidiary claims.

If according to claim 1 there is a module for determining geographical positions and an assembly for the ascertainment and output of distances, and if the organiser is provided with an interface with which the organiser can exchange data with the module for determining geographical positions and the assembly for the ascertainment and output of distances, it is ensured that on the basis of the data available the user is always given a realistic message for reaching the next appointment. Possible changes of location after entering the appointment are unimportant if according to claim 2 at least once before the recorded appointment the location is ascertained with the aid of the data from the module for determining geographical positions and the travelling time to the address of the appointment is ascertained by means of the assembly for the ascertainment and output of distances, and the organiser gives a signal when the instantaneous time plus the ascertained travelling time or plus the ascertained travelling time and a safety margin corresponds to the time of the appointment. This can be done e.g. periodically or at other predetermined intervals of time.

The entry of data in the organiser is reduced if according to claim 3 the organiser is provided with a matching assembly which, from the recorded appointment data, ascertains the address for the appointment location from an existing file or address file.

If according to claim 4 at least once before output of the signal current messages are scanned and if occasion arises included in the ascertainment of travelling time, it is ensured that the signal is emitted in such good time that the appointment is reached reliably, without the user being reminded of the appointment too early. If the organiser is provided with an additional interface which can exchange data with a data source of an assembly separate from the organiser, and if the data of the data source are scanned and/or displayed as a function of the time entered in the calendar, further facts connected with the appointment can be influenced automatically or manually.

### BRIEF ACCOUNT OF THE FIGURES

They show:

FIG. 1 a first assembly according to the invention and

FIG. 2 a further assembly according to the invention.

### Ways of Executing the Invention

The invention will now be described in more detail with the aid of the figures.

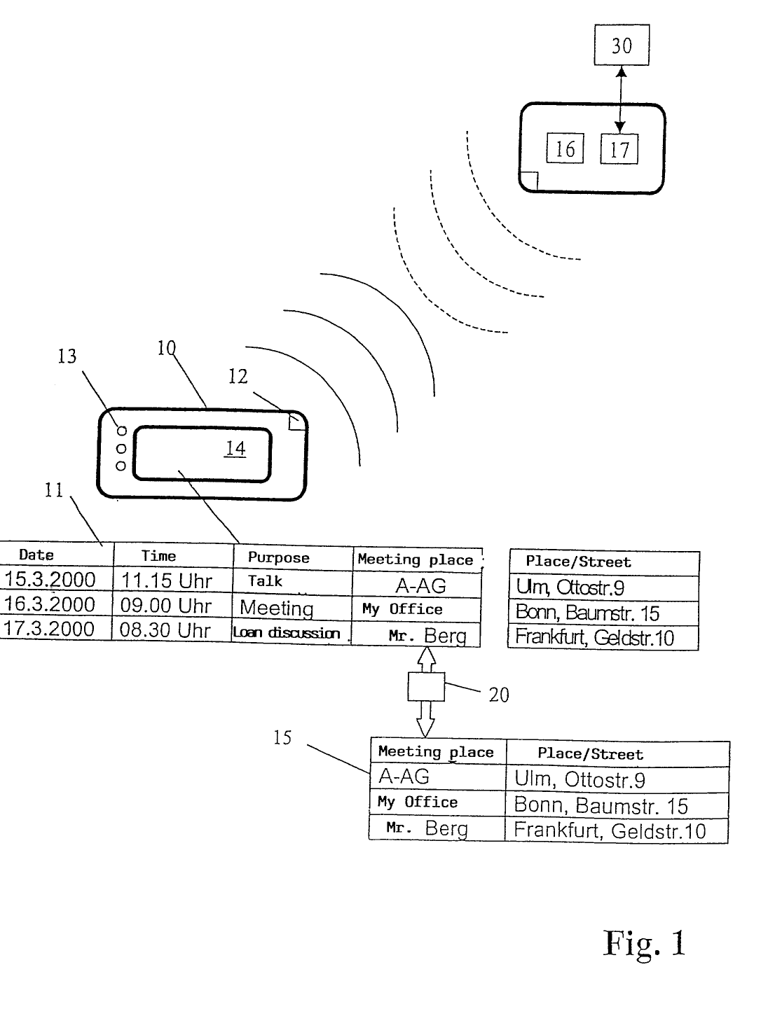

In FIG. 1 an organiser is shown with the reference number 10. This organiser 10 includes, apart from a calendar 11 (memory section), a first interface 12. To show the conditions better, in FIG. 1 the calendar 11 is illustrated in an enlarged form below the organiser 10. It can be seen clearly from the drawing of the calendar 11 that in the present case the latter has four columns (date, time, purpose and meeting place) and has a plurality of rows, of which however only three are shown in FIG. 1 and already have appointments or appointment details written in.

The entry of a new appointment is presently organised in such a way that, on actuation of a corresponding function button 13 on the organiser 10, an empty row on the display 14 of the organiser 10 is made available to the user, which he must then fill in with data for his appointment according to the headings of the columns. To enter the appointment which is shown in the first row shown in FIG. 1, the user via a keyboard (not shown) would have had to make an entry of “15.3.2000” in the first column, an entry of “11.15” in the second column, an entry of “talk” in the third column and an entry of “A-AG” in the fourth column. It is striking that, apart from the entries just mentioned, no indication of address is required of the user. Instead, the address is added beside the respective appointment entry due to the fact that there is an address file 15 in the organiser 10, which is linked to the calendar 11 through the meeting place column and has a matching assembly 20. The link is shown with the double arrow in FIG. 1. Because of this link, on entering the respective meeting place the address relevant to this entry is found in the address file 15 and connected with the respective appointment. For the appointment entered in the first row in FIG. 1 this means that, with reference to the entry “A-AG” made in the meeting place column, the associated address “Ulm, Ottostr. 9” is found in the address file 15 which is also provided with a meeting place column for this purpose, and connected with the row entry in the calendar 11. Whether the exact address ascertained with reference to the meeting place is indicated in the calendar 11 or not, is of no importance to the manner of operation of the invention. If however it is indicated, this can be an advantage to the user. If for example A-AG has several branches the user can, if the addresses of the branches are indicated to him, with the entry simultaneously select the address of the branch of A-AG which is relevant to his appointment.

Only for the sake of completeness it should be pointed out that the calendar 11 does not necessarily have to be connected with the address file via the meeting place column. Instead, in another embodiment not shown the respective address from the address file 15 can be linked via a telephone number recorded in the calendar 11 or a person's name, if suitable columns are provided instead of the meeting place columns in the calendar 11 and address file 15.

When the appointments have been entered in the organiser 10, monitoring of appointments according to the invention can begin. For this, it is necessary for there to be a module 16 for determining geographical positions and an assembly 17 for the ascertainment of distances. Moreover it is necessary for the organiser 10 to be able to exchange data via a first interface with the module 16 and the assembly 17. In this case it is not necessary for the organiser 10 according to FIG. 1 to be connected to the module 16 and the assembly 17 via an air gap. Instead, in another embodiment not shown further, the organiser 10 can be connected to the module 16 and/or the assembly 17 to form a physical unit.

But for the other embodiments it is assumed according to FIG. 1 that the module 16 and the assembly 17 are parts of a motor vehicle installation, and that the module 16 and the assembly 17 are connected to the organiser 10 via an air gap. Only for the sake of completeness it should be pointed out that the module 16 is a GPS module (global positioning system) and that the assembly 17 for the ascertainment and output of distances is one which has already gained acceptance in large numbers as a navigation assembly, for example in motor vehicles.

When a new appointment has been entered in the calendar 11, it is necessary at least once before the recorded appointment for the geographical position to be determined with reference to the data from the module 16 and for the travelling time to the address of the appointment to be ascertained by means of the assembly 17 for the ascertainment and output of distances. How the travelling time is ascertained, is described below.

To ensure that the appointment is always reached, but at the same time data exchange is reduced to a minimum, in the present case data exchange is organised in such a way that, on entering a new appointment, immediately the travelling time and the instantaneous distance from the destination are ascertained. Since, according to the embodiment as in FIG. 1, the unit consisting of module 16 and assembly 17 is spatially separate from the organiser, because the unit consisting of module 16 and assembly 17 can still be moved in the meantime it is provided that, in case of a change of location by an amount of for example 50 kilometres, a new calculation of time is made. If it is assumed that the vehicle was no longer moved after entry of the appointment in the first row of the calendar 11, a signal is emitted by the organiser 10 when the instantaneous time plus the ascertained travelling time or plus the ascertained travelling time and a safety margin corresponds to the time of the appointment.

In order to convert the distance between the instantaneous location and the appointment location to a time, it may be provided that the user makes manual settings by, for example, entering an average speed of 100 km/h for travelling on motorways and one of 70 km/h on ordinary roads. Because the entry of average speeds in addition to the expenditure of time can also very easily lead to incorrect entries, in another embodiment this entry can be taken over by a self-learning system in which the driving behaviour of the driver is analysed for different types of roads and different times of day.

Also it may be provided that the time which is needed to deal with the distance between the instantaneous location and the appointment location is ascertained with the aid of the route guide. For this it is necessary, in addition to the roads sought to the destination, for their speed limits to be known too. If the route guide is fixed, then with the aid of the known speed limits for the roads used the travelling time can be ascertained.

If after a data exchange it follows that the instantaneous time plus the ascertained travelling time to the address of the appointment or plus the ascertained travelling time and a safety margin corresponds to the time which is entered in the calendar 11 for the corresponding appointment, a reminder signal to set off is emitted to the user. Also it may be provided that for example 15 minutes before output of the reminder signal a preliminary signal is generated and emitted.

For the appointment entered in the first row of the calendar 11 according to FIG. 1 this means that, with a location of the vehicle in Stuttgart, for the road to Ulm to A-AG using one of the methods of calculating time described and used above, and with a travelling time of 1.5 hours, the user on 15.3.200 at 9.45 a.m. receives a reminder signal to set off for his appointment in Ulm. If the option is performed with a preliminary signal, this is emitted to the user at 9.30 a.m.

As it is not impossible that due to traffic congestion or bad weather the proposed road cannot be travelled within the period ascertained, it may be provided that the assembly 17 has access to a data bank 30 which makes traffic messages available. For the journey from Stuttgart to Ulm this means that, in addition to the calculation of time described above, the data bank 30 with the traffic messages is also scanned. If this scan reveals for example that on the road from Stuttgart to Ulm a traffic-related delay of 15 minutes must be expected, this information is included by the fact that the user receives the reminder signal to set off not just at 9.45 a.m., but already at 9.30 a.m.

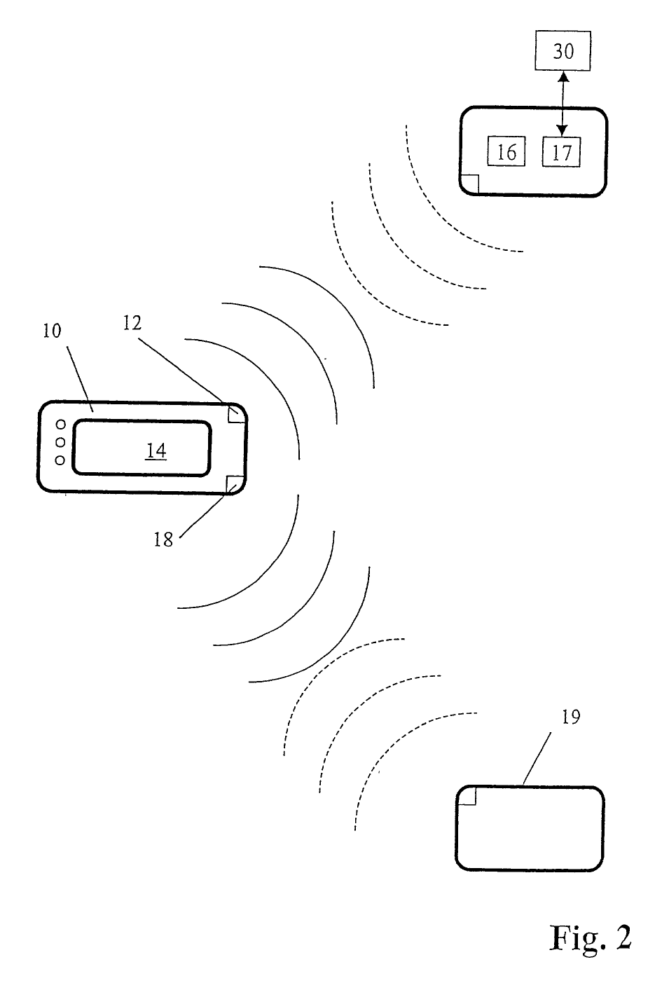

In FIG. 2, starting from the embodiment as in FIG. 1, the organiser 10 is provided with an additional interface 18. Via this interface 18, which does not necessarily have to be different to the interface 12, the organiser 10 can exchange data with an assembly 19 separate from the organiser 10. In the present case this assembly 19 is formed by a car thermometer which ascertains the temperatures prevailing in the vehicle and transmits them via a transmitting device 20 to the organiser 10. To limit data exchange between the organiser 10 and the assembly 19 to a minimum, it is provided that the data of the assembly 19 are scanned as a function of the times entered in the calendar 11 or made available to the calendar 10 by the assembly 19.

If for example temperatures below freezing have prevailed in the night from 14.3.2000 to 15.3.2000, and if the temperature in the vehicle on 15.03.2000 at 9.00 a.m. is only 2° C., this means for the journey from Stuttgart to Ulm according to the first row in FIG. 1 that this state is indicated to the user on the organiser 10 and/or he is asked via the organiser 10 the question whether the auxiliary heating is to ensure heating of the interior in good time before commencement of the journey.

Only for the sake of completeness it should be pointed out that according to the embodiments in the last paragraph for example the air conditioning system can also be switched on and/or engine preheating can be arranged.

Because, according to the previous embodiments, the organiser 10 does not form a physical unit at least with the assembly 19 and can exchange data with the latter via an air gap, the organiser 10 includes a unit for mobile communication (not shown). Such assemblies are known in the state of the art by the name of communicator or mobile telephone.

What is claimed is:

1. Electronic organiser with a calendar (11) in which there are appointments at least according to place, date and time, characterised in that the organiser (10) is provided with an interface (12) via which it can be connected to a module (16) for determining geographical positions and an assembly (17) for the ascertainment and output of distances, in order to exchange data.

2. Electronic organiser according to claim 1, characterised in that it is designed in such a way that at least once before the recorded appointment its location is ascertained with the aid of the data from the module (16) for determining geographical positions and a travelling time to the address of the appointment is ascertained by means of the assembly (17) for the ascertainment and output of distances, and in that a signal can be emitted by the organiser (10) when the instantaneous time plus the ascertained travelling time or plus the ascertained travelling time and a safety margin corresponds to the time of the appointment.

3. Electronic organiser according to claim 1, characterised in that it is designed in such a way that immediately after entry of a new appointment it ascertains its instantaneous distance from the appointment location as well as the travelling time to get there.

4. Electronic organiser according to claim 1, characterised in that it is provided with a matching assembly (20) which, from the recorded appointment data, ascertains the address for the appointment location from an existing file.

5. Electronic organiser according to claim 2, characterised in that it is designed in such a way that on ascertainment of the travelling time the delays which are critical for the distance are included by the fact that at least once before output of the signal current messages from a data bank (30) are scanned and if occasion arises included in the ascertainment of travelling time.

6. Electronic organiser according to claim 1, characterised in that it is provided with an additional interface (18) which can exchange data with a data source of an assembly (19) separate from the organiser (10), and in that the data of the data source can be scanned and/or displayed as a function of the times entered in the calendar (11).

7. Electronic organiser according to claim 1, characterised in that it includes the module (16) for determining geographical positions and the assembly (17) for the ascertainment and output of distances.

8. Method of planning appointments using an electronic organiser (10) in which appointments are entered at least according to place, date and time, characterised in that after entry of an appointment the required travelling time to the appointment location is ascertained and the user is given a signal at the latest when the sum of instantaneous time plus the ascertained travelling time corresponds to the appointment time.

9. Method according to claim 8, characterised in that a safety margin is included in the ascertained travelling time.

10. Method according to claim 8, characterised in that to ascertain the travelling time the electronic organiser (10) cooperates with a module (16) for determining its geographical position and an assembly (17) for the ascertainment and output of distances, in order to determine the travelling time with reference to a calculated distance between instantaneous position and appointment location.

11. Method according to claim 10, characterised in that when determining the travelling time the means of transport and/or the condition of the road are taken into account.
